(19) United States
(12) Patent Application Publication
(10) Pub. No.: US 2016/0124816 A1
(43) Pub. Date: May 5, 2016

(54) COMPUTING DEVICE AND METHOD FOR RECOVERING BIOS OF COMPUTING DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/547,332

(22) Filed: Nov. 19, 2014

(30) Foreign Application Priority Data
Oct. 30, 2014 (TW) 103137527

(51) Int. Cl. G06F 11/14; G06F 13/42; G06F 9/44

(52) U.S. Cl. CPC G06F 11/1469; G06F 9/4406; G06F 13/4282; G06F 2201/86

(57) ABSTRACT

In a method and system for recovering a basic input-output system (BIOS) of a computing device, the computing device includes a serial peripheral interface (SPI) read-only memory (ROM) and a super I/O (SIO) controller. The SPI ROM stores a BIOS booting block and a main BIOS. The SIO controller connects to an universal serial bus (USB) storage that stores a

BIOS booting block file. The system retrieves a BIOS booting block file from the USB storage and writes data of the BIOS booting block file into a cache of the SIO controller when the BIOS booting block of the SPI ROM is damaged, and recovers the BIOS booting block of the SPI ROM using the data of the BIOS booting block file. The system retrieves data of a backup BIOS from the storage device to recover the main BIOS of the SPI ROM when the main BIOS is damaged.

### CROSS-REFERENCE TO RELATED APPLICATIONS

This application claims priority to Taiwanese Patent Application No. 103137527 filed on Oct. 30, 2014, the contents of which are incorporated by reference herein.

### FIELD

The subject matter herein generally relates to computer error recovery systems and methods, and particularly to a computing device and method for recovering a basic input-output system (BIOS) of the computing device.

### BACKGROUND

For booting a computing device, a basic input-output system (BIOS) of the computing device is initiated. In executing the BIOS, a power-on self test (POST) is performed to confirm that hardware of the computing device is operating normally. When the POST is finished, the BIOS tries to read a sector of the hard disk called the master boot record (MBR). Data in the MBR is loaded into a memory to be executed, and then the operating system (OS) is loaded.

If errors occur in the BIOS, a BIOS stored in a flash memory of the computing device needs to be recovered to boot the computing device instead. However, it is difficult or problematic to recover the BIOS if main program codes of the BIOS are damaged. Thus, the computing device may need to be returned to the original manufacturer to recover the BIOS.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a computing device including a basic input-output system (BIOS) recovery system.

FIG. 2 is a block diagram illustrating function modules of a BIOS recovery system included in the computing device.

FIG. 3 is a flowchart of an example embodiment of a method for recovering a basic input-output system (BIOS) of the computing device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

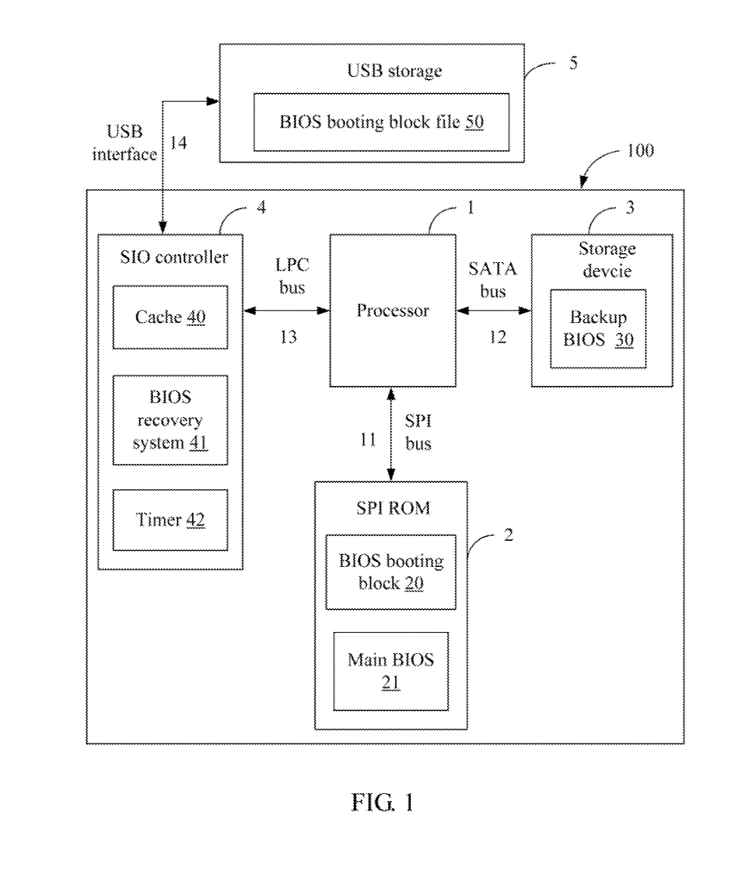

FIG. 1 is a block diagram of an example embodiment of a computing device 100 including a basic input-output system (BIOS) recovery system 41. In the embodiment, the computing device 100 includes, but is not limited to, at least one processor 1, a serial peripheral interface (SPI) read-only memory (ROM) 2, a storage device 3, and a super I/O (SIO) controller 4. The BIOS recovery system 41 is embedded in the SIO controller 4 (such as a RAM of the SIO controller 4), and is implemented by the at least one processor 1 of the computing device 100. The SPI ROM 2 connects to the at least one processor 1 through a SPI bus 11, the storage device 3 connects to the at least one processor 1 through a serial advanced technology attachment (SATA) bus 12, and the SIO controller 4 connects to the at least one processor 1 through a low pin count (LPC) bus 13. In at least one embodiment, the computing device 100 may be a personal computer, a server computer, a workstation computer, a notebook computer, or other computing system.

In the embodiment, the computing device 100 connects to a universal serial bus (USB) storage 5 through a USB interface 14. The USB storage 5 stores a BIOS booting bock file 50 which contains data of BIOS booting bock in form of a binary format. The USB storage 5 is an external hard disk, such as an U-disk, a storage card, or other external data storage medium.

The at least one processor 1 is a central processing unit (CPU) or microprocessor that performs various functions of the computing device 100. In at least one embodiment, the storage device 3 may be an internal storage system, such as a flash memory, a random access memory (RAM) for temporary storage of information, and/or a read only memory (ROM) for permanent storage of information. The storage device 3 may also be an external storage system, such as an external hard disk, a storage card, or a data storage medium.

The SPI ROM 2 is a BIOS memory that stores a BIOS booting block 20 and a main BIOS 21. In the embodiment, the BIOS booting block 20 invokes the main BIOS 21 to perform a power-on self test (POST) for the computing device 100 when the computing device 100 is powered on. The main BIOS 21 is executed to perform the POST process of the computing device 100 and load an operating system (OS) of the computing device 100.

The storage device 3 stores a backup BIOS 30, which is identical to the main BIOS 22 stored in the SPI ROM 2. The backup BIOS 30 is used to recover the main BIOS 21 of the SPI ROM 2 when the main BIOS 21 of the SPI ROM 2 is damaged, so as to make sure that the computing device 100 is powered on normally. In at least one embodiment, the main BIOS 21 of the SPI ROM 2 may be partially damaged (e.g., data corruption) because a part of data of the main BIOS 21 is corrupted or damaged. In other embodiment, the main BIOS 21 may be fully erased (e.g., data erase) from the SPI ROM 2 when the SPI ROM 2 occurs physical errors.

The SIO controller 4 is a super I/O embedded controller located at a LPC chipset, and monitors and manages hardware of the computing device 100, including a hard disk drive (HDD), a printer, a power supply, a audio card, and a video card, through COM ports and serial ports. The SIO controller 4 includes a cache 4 for temporarily storing the BIOS booting bock file 50 obtained from the USB storage 5 when the BIOS booting block 20 stored in the SPI ROM 2 is damaged. In the embodiment, the SIO controller 4 includes further includes a timer 42 to monitor a power-on self test (POST) procedure of the computing device 100. In the embodiment, the timer 42 can be a software monitor (such as a monitor dog) or a hardware monitor that counts a time period while the SIO controller 4 monitors the POST procedure of the computing device 100.

In at least one embodiment, the BIOS recovery system 41 may comprise computerized instructions in the form of one or more program codes that are embedded in a flash ROM of the SIO controller 4. The BIOS recovery system 41 may also be stored in a non-transitory computer-readable medium such as the storage device 3. When the main BIOS 21 of the SPI ROM 2 is damaged, the BIOS recovery system 40 obtains the backup BIOS 30 from the storage 3 to recover the main BIOS 21 of the SPI ROM 2. When the BIOS booting block 20 of the SPI ROM 2 is damaged, the BIOS recovery system 41 obtains the BIOS booting bock file 50 from the USB storage 5, temporarily stores the BIOS booting bock file 50 into the cache 40 to recover the BIOS booting block 20 of the SPI ROM 2, and powers on the computing device 100 using the BIOS booting bock file 50 of the cache 40. When the BIOS booting block 20 and the main BIOS 21 of the SPI ROM 2 are not damaged, the BIOS recovery system 41 executes the BIOS booting block 20 to perform the main BIOS 21 of the SPI ROM 2, and powers on the computing device 100 normally using the BIOS booting block 20 of the SPI ROM 2.

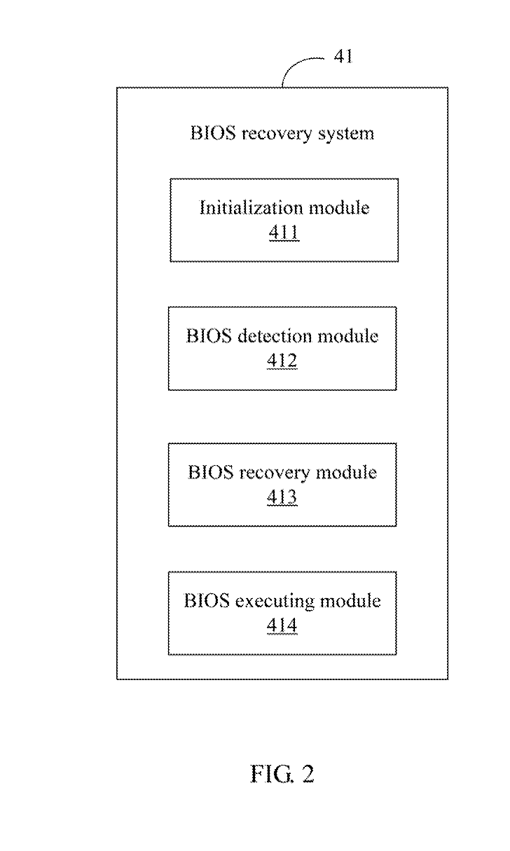

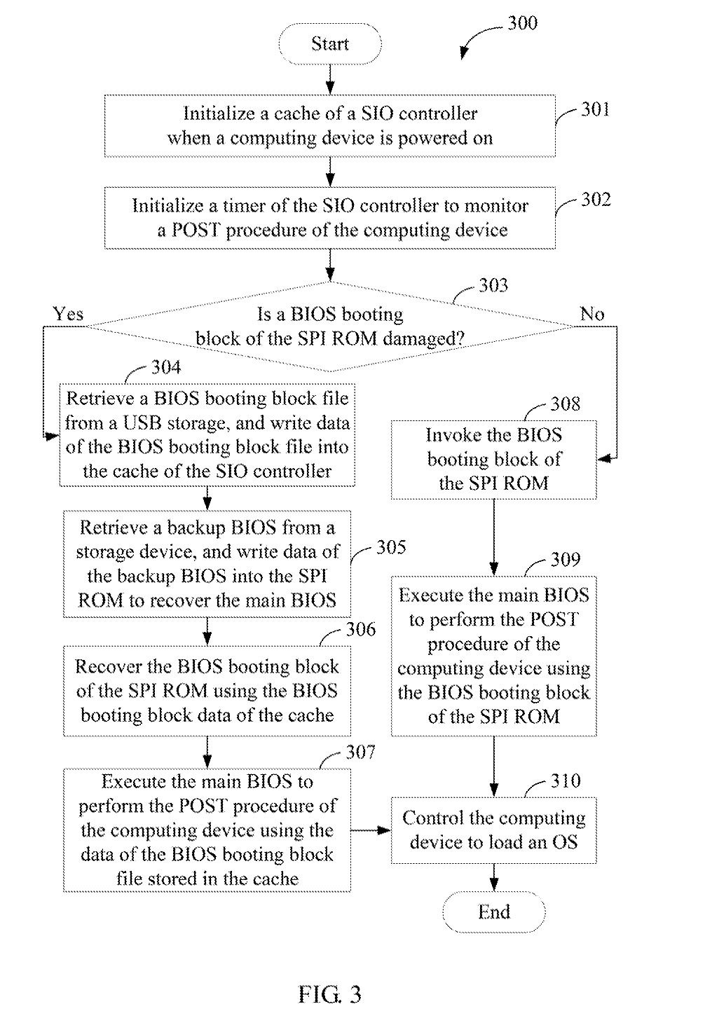

FIG. 2 is a block diagram illustrating function modules of the BIOS recovery system 41. In the embodiment, the BIOS recovery system 41 includes an initialization module 411, a BIOS detection module 412, a BIOS recovery module 413, and a BIOS executing module 414. The modules 411-414 may comprise computerized instructions in the form of one or more computer-readable programs that are stored in a non-transitory computer-readable medium (such as the storage device 3 or a memory of the SIO controller 4) and executed by the at least one processor 1. The modules 411-414 can be include the computerized instructions to execute the method as described below in relation to FIG. 3.

FIG. 3 illustrates a flowchart of an example embodiment of a method for recovering a basic input-output system (BIOS) of a computing device. In the example embodiment, the method 300 is performed by execution of computer-readable software program codes or instructions by at least one processor of a computing device, such as the computing device 100 of FIG. 1.

Referring to FIG. 3, a flowchart is presented in accordance with an example embodiment. In the embodiment, the example method 300 is provided by way of example only as there are a variety of ways to carry out the method. The method 300 described below can be carried out using the configurations illustrated in FIG. 1 and FIG. 2, for example, and various elements of the figure are referenced in explaining the example method 300. Each block shown in FIG. 3 represents one or more processes, methods or subroutines, carried out in the exemplary method 300. Furthermore, the illustrated order of blocks is by example only and the order of the blocks can be changed according to the present disclosure. Additional blocks may be added or fewer blocks may be utilized, without departing from this disclosure. The exemplary method 300 can begin at block 301.

At block 301, the initialization module 411 initializes the cache 40 of the SIO controller 4 when the computing device 100 is powered on. In the embodiment, the cache 4 is used to temporarily store the BIOS booting bock file 50 obtained from the USB storage 5 when the BIOS booting block 20 stored in the SPI ROM 2 is damaged.

At block 302, the initialization module 411 initializes a timer 42 of the SIO controller 4 to monitor a power-on self test (POST) procedure of the computing device 100, and counts a time period using the timer 42 during the POST procedure of the computing device 100. In the embodiment, the timer 42 can be a software monitor (such as a monitor dog) that counts a time period while the SIO controller 4 monitors the POST procedure of the computing device 100. The timer 42 can also a hardware monitor that monitors hardware of the computing device 100, including a hard disk drive (HDD), a printer, a power supply, a audio card, and a video card, through COM ports and serial ports.

At block 303, the BIOS detection module 412 detects whether the BIOS booting block 20 of the SPI ROM 2 is damaged. In the embodiment, the BIOS detection module 411 detects whether the BIOS booting block 20 of the SPI ROM 2 is damaged by determining whether the time period is equal to a predefined time value such as 30 seconds. When the time period is equal to the predefined time value, the BIOS detection module 411 checks whether the computing device 100 powers on normally or abnormally, and determines that the BIOS booting block 20 of the SPI ROM 2 is damaged if the computing device 100 does not power on normally. If the BIOS booting block 20 of the SPI ROM 2 is damaged, block 304 is implemented. Otherwise, if the BIOS booting block 20 of the SPI ROM 2 is not damaged, block 308 is implemented.

At block 304, the BIOS recovery module 413 retrieves data of the BIOS booting bock file 50 from the USB storage 5 through the USB interface 14, and writes the data of the BIOS booting bock file 50 into the cache 40 of the SIO controller 4. In the embodiment, the BIOS booting bock file 50 is a binary data file which contains data of the BIOS booting block 20 in form of a binary format.

At block 305, the BIOS recovery module 413 retrieves data of the backup BIOS 30 from the storage device 3 when the main BIOS 21 is damaged, and writes the data of the backup BIOS 30 into the SPI ROM 2 to recover the main BIOS 21. In the embodiment, the BIOS recovery module 413 obtains a copy of the backup BIOS 30 from the storage device 3 through the STAT bus 12, and transmits the copy of the backup BIOS 30 through the SPI bus 11 to recover the damaged data of the main BIOS 21 stored in the SPI ROM 2.

At block 306, the BIOS recovery module 413 recovers the BIOS booting block 20 of the SPI ROM 2 using the data of the BIOS booting bock file 50 stored in the cache 40 of the SIO controller 4. In the embodiment, the BIOS recovery module 413 obtains a copy of the data of the BIOS booting bock file 50 from the cache 40 of the SIO controller 4 through the LPC bus 13, and recovers the damaged data of the BIOS booting block 20 stored in the SPI ROM 2 using the copy of the data of the BIOS booting bock file 50.

At block 307, the BIOS executing module 414 executes the main BIOS 21 to perform the POST procedure of the computing device 100 using the data of the BIOS booting bock file 50 stored in the cache 40.

At block 308, the BIOS executing module 414 invokes the BIOS booting block 20 of the SPI ROM 2. At block 309, the BIOS executing module 414 executes the main BIOS 21 of the SPI ROM 2 to perform the POST procedure of the computing device 100 using the BIOS booting block 20 of the SPI ROM 2. At block 310, the BIOS executing module 414 controls the computing device 100 to enter an OS (such as a WINDOWS OS or a LUNIX OS) of the computing device 100, and completes the booting procedure of the computing device 100.

All of the processes described above may be embodied in, and fully automated via, functional code modules executed by one or more general purpose processors of computing devices. The code modules may be stored in any type of non-transitory readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. A computing device, comprising:
a serial peripheral interface (SPI) read-only memory (ROM) configured to store a basic input-output system (BIOS) booting block and a main BIOS;
a super I/O (SIO) controller connected to an universal serial bus (USB) storage that stores a BIOS booting block file; and
a storage device configured to store a computer-readable program comprising instructions that, when executed by at least one processor, cause the at least one processor to:
initialize a cache of the SIO controller when the computing device is powered on;
detect whether the BIOS booting block of the SPI ROM is damaged;
retrieve the BIOS booting block file from the USB storage when the BIOS booting block is damaged, and write data of the BIOS booting block file into the cache of the SIO controller;
retrieve data of a backup BIOS from the storage device when the main BIOS is damaged, and write the data of the backup BIOS into the SPI ROM to recover the main BIOS of the SPI ROM;
recover the BIOS booting block of the SPI ROM using the data of the BIOS booting block file stored in the cache; and
execute the main BIOS to perform a power-on self test (POST) procedure of the computing device using the BIOS booting block of the SPI ROM.

2. The computing device according to claim 1, wherein the computer-readable program further causes the at least one processor to initialize a timer of the SIO controller to monitor the POST procedure of the computing device, and count a time period using the timer during the POST procedure of the computing device.

3. The computing device according to claim 2, wherein the BIOS booting block of the SPI ROM is detected to be damaged by performing steps of:
determining whether the time period is equal to a predefined time value;
checking whether the computing device powers on normally when the time period is equal to the predefined time value; and
determining that the BIOS booting block of the SPI ROM is damaged if the computing device does not power on normally.

4. The computing device according to claim 1, wherein the computer-readable program further causes the at least one processor to:
invoke the BIOS booting block of the SPI ROM when the BIOS booting block;
execute the main BIOS of the SPI ROM to perform the POST procedure of the computing device using the BIOS booting block of the SPI ROM; and
control the computing device to enter an operating system (OS) of the computing device.

5. The computing device according to claim 1, wherein the cache of the SIO controller temporarily stores the data of the BIOS booting block file retrieved from the USB storage when the BIOS booting block of the SPI ROM is damaged.

6. The computing device according to claim 1, wherein the data of the BIOS booting bock is stored in form of a binary format in the USB storage, and the USB storage connects to the SIO controller through a USB interface.

7. A method for recovering a basic input-output system (BIOS) of a computing device, the computing device comprising a serial peripheral interface (SPI) read-only memory (ROM), and a super I/O (SIO) controller, the method comprising:
initializing a cache of the SIO controller when the computing device is powered on;
detecting whether a BIOS booting block stored in the SPI ROM is damaged;
retrieving a BIOS booting block file from the USB storage when the BIOS booting block is damaged, and writing data of the BIOS booting block file into the cache of the SIO controller;
retrieving data of a backup BIOS from the storage device when a main BIOS stored in the SPI ROM is damaged, and writing the data of the backup BIOS into the SPI ROM to recover the main BIOS of the SPI ROM;
recovering the BIOS booting block of the SPI ROM using the data of the BIOS booting block file stored in the cache; and
executing the main BIOS to perform a power-on self test (POST) procedure of the computing device using the BIOS booting block of the SPI ROM.

8. The method according to claim 7, further comprising:
initializing a timer of the SIO controller to monitor the POST procedure of the computing device; and
counting a time period using the timer during the POST procedure of the computing device.

9. The method according to claim 8, wherein the BIOS booting block of the SPI ROM is detected to be damaged by performing steps of:
determining whether the time period is equal to a predefined time value;
checking whether the computing device powers on normally when the time period is equal to the predefined time value; and
determining that the BIOS booting block of the SPI ROM is damaged if the computing device does not power on normally.

10. The method according to claim 7, further comprising:
invoking the BIOS booting block of the SPI ROM when the BIOS booting block;
executing the main BIOS of the SPI ROM to perform the POST procedure of the computing device using the BIOS booting block of the SPI ROM; and
controlling the computing device to enter an operating system (OS) of the computing device.

11. The method according to claim 7, wherein the cache of the SIO controller temporarily stores the data of the BIOS booting block file retrieved from the USB storage when the BIOS booting block of the SPI ROM is damaged.

12. The method according to claim 7, wherein the data of the BIOS booting bock is stored in form of a binary format in the USB storage, and the USB storage connects to the SIO controller through a USB interface.

13. A non-transitory storage medium having stored thereon instructions that, when executed by at least one processor of a computing device, causes the least one processor to execute instructions of a method for automatically recovering a basic input-output system (BIOS) of the computing device, the computing device comprising a serial peripheral interface (SPI) read-only memory (ROM), and a super I/O (SIO) controller, the method comprising:
initializing a cache of the SIO controller when the computing device is powered on;
detecting whether a BIOS booting block stored in the SPI ROM is damaged;
retrieving a BIOS booting block file from the USB storage when the BIOS booting block is damaged, and writing data of the BIOS booting block file into the cache of the SIO controller;
retrieving data of a backup BIOS from the storage device when a main BIOS stored in the SPI ROM is damaged, and writing the data of the backup BIOS into the SPI ROM to recover the main BIOS of the SPI ROM;
recovering the BIOS booting block of the SPI ROM using the data of the BIOS booting block file stored in the cache; and
executing the main BIOS to perform a power-on self test (POST) procedure of the computing device using the BIOS booting block of the SPI ROM.

14. The storage medium according to claim 13, wherein the method further comprises:
initializing a timer of the SIO controller to monitor the POST procedure of the computing device; and
counting a time period using the timer during the POST procedure of the computing device.

15. The storage medium according to claim 14, wherein the BIOS booting block of the SPI ROM is detected to be damaged by performing steps of:
determining whether the time period is equal to a predefined time value;
checking whether the computing device powers on normally when the time period is equal to the predefined time value; and
determining that the BIOS booting block of the SPI ROM is damaged if the computing device does not power on normally.

16. The storage medium according to claim 13, wherein the method further comprises:
invoking the BIOS booting block of the SPI ROM when the BIOS booting block;
executing the main BIOS of the SPI ROM to perform the POST procedure of the computing device using the BIOS booting block of the SPI ROM; and
controlling the computing device to enter an operating system (OS) of the computing device.

17. The storage medium according to claim 13, wherein the cache of the SIO controller temporarily stores the data of the BIOS booting block file retrieved from the USB storage when the BIOS booting block of the SPI ROM is damaged.

18. The storage medium according to claim 13, wherein the data of the BIOS booting bock is stored in form of a binary format in the USB storage, and the USB storage connects to the SIO controller through a USB interface.
